(19) United States
(12) Patent Application Publication
(10) Pub. No.: US 2008/0313087 A1
(43) Pub. Date: Dec. 18, 2008

(54) AUTOMATED TELLER MACHINE HAVING ACCESS POINT AND METHOD FOR PROVIDING FINANCIAL SERVICE USING THE SAME

(76) Inventors: Vinod Cherian JOSEPH, Bangalore (IN); Sung Ho AHN, Daejeon-city (KR); Kyung Hee LEE, Daejeon-city (KR); Doo Hyun KIM, Kyungki-do (KR)

Correspondence Address: LADAS & PARRY LLP, 224 SOUTH MICHIGAN AVENUE, SUITE 1600, CHICAGO, IL, 60604, US

(21) Appl. No.: 12/199,129

(22) Filed: Aug. 27, 2008

Related U.S. Application Data
(62) Division of application No. 11/145,660, filed on Jun. 6, 2005.

(30) Foreign Application Priority Data
Oct. 22, 2004 (KR) 10-2004-0084807

(51) Int. Cl. G06Q 40/00; G06Q 20/00; H04L 9/32

(52) U.S. Cl. 705/66; 705/43

(57) ABSTRACT

An automated teller machine (ATM) having a wireless network access apparatus and a method for providing financial services using the ATM are provided. The ATM includes a user interface unit, a first financial processing unit, a first network access unit, a second network access unit, and a second financial service unit. The user interface unit performs data communication with a storage medium on which information is recorded, and outputs information to a user through an output apparatus. The first financial processing unit provides financial services including account inquiry, deposit, and withdrawal, by performing data communication processes with a recognized storage medium. The first network access unit is connected to an ATM network connected to a financial institution server, transmits data obtained as a result of performing financial services, to the financial institution server, and receives processed data from the financial institution server. The second network access unit is connected to an access point establishing a communication path for a wireless communication terminal of the user traveling in a predetermined communication area, and activating wireless communication. The second financial service unit performs data communication with the wireless communication terminal of the user through the access point, and provides at least one or more of financial services, digital token delivery service, and V2oIP service.

### CROSS-REFERENCE TO RELATED PATENT APPLICATIONS

This application claims the benefit of Korean Patent Application No. 10-2004-0084807, filed on Oct. 22, 2004, in the Korean Intellectual Property Office, the disclosure of which is incorporated herein in its entirety by reference.

### BACKGROUND OF THE INVENTION

1. Field of the Invention

The present invention relates to an automated teller machine (ATM) having a wireless communication network access apparatus, and more particularly, to an ATM having a wireless communication network access apparatus capable of providing additional financial service and Internet access service when installed in a public place, and a method for providing financial services using the ATM.

2. Description of the Related Art

The prior art closest to the present invention is U.S. Pat. No. 5,796,832, “Wireless transaction and information system”. The prior art disclosed in the U.S. Pat. No. 5,796,832 is wireless transaction and an information system using wireless communication in connection with portable terminals. In this system, a terminal is connected to the financial institution via a wireless or cellular telephone hook-up. Smart cards are utilized to verify authorization for transactions, thereby reducing security problems that can be caused by the use of a mobile terminal. In addition to the authorization, smart cards are also used to maintain security records of available funds. This system does not only provide the functionality of an ATM network, but also provides non-financial services, thereby forming an integrated system.

Another prior art related to the present invention is the U.S. Pat. No. 5,220,501, “Method and system for remote delivery of retail banking services”. The method and system includes a practical system and method for the remote distribution of financial services (that is, home banking and bill-paying), and includes distributing portable terminals to a user base. The terminals include a multi-line display, a plurality of keys pointing to lines on the display, and additional keys. A contact point is installed between terminals generally connected through telephone networks and packet data networks, and a central computer run by a service provider. Information exchanged between the central computer and the terminals includes information received from a terminal user in relation to a requested financial service (that is, for bill payment, the user provides payee selection, payment amount and his bank account number). Next, the central computer transmits a message debiting the user's bank account through an ordinary ATM network in real time, can pay the specified payees the specified amount electronically or in other ways as appropriate. Payments and transfers may be scheduled in advance or on a periodic basis. Since the central computer interacts with the user's bank as a standard POS or ATM network node, no significant software changes are required at the banks' computers. In order not to give difficulty to a new user, the terminal interface is user-friendly and corresponds with some features of standard ATM user interfaces.

As described above, the wireless transaction and information system disclosed in the U.S. Pat. No. 5,796,832 relates mainly to the design of the wireless smart card system that can be used by a user and an independent wireless LAN network. In this system, a terminal is directly corrected to the server of the financial institution in a wireless method such as a wireless LAN and a cellular network. Also, the method and system for remote delivery of retail banking services disclosed in the U.S. Pat. No. 5,220,501 promotes distributions of customer-oriented mobile terminals for remote financial services. Then, the customer-oriented terminals are connected to banks through the telephone network or the packet data network run by the service provider. The method and system for remote delivery of retail banking services disclosed in the U.S. Pat. No. 5,220,501 focus on connection to an ATM network in order to provide simple financial services through copying in an ATM.

Thus, the conventional technologies have drawbacks that additional services should be provided through a wireless network separate from the existing backbone networks of banks or a customer who wants to receive additional services should have a separate terminal. Accordingly, the conventional technologies cause additional costs in order to provide additional services.

### SUMMARY OF THE INVENTION

The present invention provides an ATM having a wireless communication network access apparatus capable of improving customer services provided by banks, promoting Internet use of ISPs, and more importantly, enabling a user in a public place to access the Internet at a cheaper expense, and a method for providing financial services using the ATM.

According to an aspect of the present invention, there is provided an automated teller machine (ATM) having a wireless communication network access apparatus including: an interface unit performing data communication with a storage medium capable of recording and reading data by any one of electricity and magnetism and providing a unit outputting information to a user through an information output apparatus; a first financial processing unit providing financial services including account inquiry, deposit, and withdrawal, by performing data communication processes with a recognized storage medium; a first network access unit connected to an ATM network connected to a financial institution server, transmitting data obtained as a result of the first financial processing unit performing the financial services, to the financial institution server, receiving processed data from the financial institution server and transferring the data to the first financial processing unit; a second network access unit connected to an access point establishing a communication path for a wireless communication terminal of the user traveling in a predetermined communication area, and activating wireless communication; and a second financial service unit performing data communication with the wireless communication terminal of the user through the access point connected to the second network access unit, and providing at least one or more of the financial services, a delivery service of a digital token capable of buying goods and services, and a video and voice over IP (V2oIP) service including public Internet access.

According to another aspect of the present invention, there is provided a method for providing financial services by using an ATM installed in a public place including a shopping mall and providing financial services including account inquiry, deposit and withdrawal, the method including: sensing a wireless communication terminal of a user traveling in the communication area of an access point disposed in the ATM; activating a mobile agent installed in the sensed wireless communication terminal of the user, and asking the user through the wireless communication terminal whether or not the user requests a digital token capable of buying goods and services; and if a message requesting to deliver the digital token from the wireless communication of the user is received, transmitting a digital token corresponding to the user to the wireless communication terminal of the user.

According to the ATM and method, shopping and financial transactions performed in the traditional environment can be changed, and by promoting use of digital cash tokens or printed cash tokens, crimes occurring in shopping malls can be prevented.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a service performing process in a shopping mall in which an ATM having an access point according to the present invention is installed;

FIG. 2 is a flowchart of a purchasing process of a user using a digital token in a shopping mall;

FIG. 3 illustrates services provided by an ATM having an access point according to the present invention;

FIG. 4 illustrates an operation profile of software installed in an ATM having an access point according to the present invention;

FIG. 5 illustrates a protocol stack of an ATM having an access point according to the present invention;

FIG. 6 illustrates a basic infrastructure providing interconnectivity and security between a financial service network and a service provider network;

FIG. 7 illustrates a detailed structure of an ATM access point implemented as a chip according to the present invention;

FIG. 8 is a block diagram of the hardware structure of an ATM having an access point according to the present invention;

FIG. 9 illustrates a service stack structure and service flow of an ATM having an access point according to the present invention;

FIG. 10 illustrates the appearance of an ATM having an access point according to the present invention; and

FIG. 11 illustrates a money transfer process when a user uses a digital token in a shop through an ATM having an access point according to the present invention.

### DETAILED DESCRIPTION OF THE INVENTION

The present invention will now be described more fully with reference to the accompanying drawings, in which exemplary embodiments of the invention are shown. Hereinafter, an access point means a wireless communication network access apparatus according to the present invention.

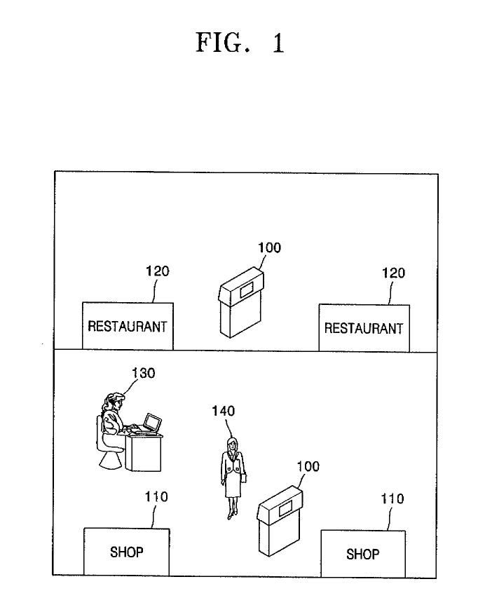

Referring to FIG. 1, an ATM having an access point according to the present invention is installed in a public place such as a shopping mall, in place of a conventional ATM. This ATM has already formed an essential part of a broadband network and a wireless LAN is a very important popular means to access the Internet in a café or a public place. FIG. 1 shows an ATM integrating an access point according to the present invention installed in a shopping mall. The typical shopping mail is formed with a plurality of shops 110 and restaurants 120.

When a family has meals in the restaurant 120, users 130 and 140 may want to use a wireless Internet service enabling financial transactions. This service and other public Internet services can be provided by implementing a wireless local area network (WLAN) access point on a bank ATM base. The laptop computer user 130 or a PDA/smart phone user 140 checks their accounts through a security wireless infrastructure provided by the ATM WLAN access point and establishes a connection to the ATM WLAN access point. A user who enters the shopping mail is automatically sensed in a predetermined area by a financial institution network tied up with the shopping mall, and is given a series of discount tokens.

For example, the user 130 and 140 entering into the shopping mall can be given a special 50% discount for products of a predetermined company sold in a predetermined shop in the form of a digital token by a financial institution. At this time, if the user 130 and 140 is interested in the discount, the digital token is used to buy a service in the shop, or else the digital token is removed. This series of services promote reduction of expenses of the shop in relation to marketing and increase customer profiles of the financial institution.

Similarly, the user 130 and 140 may also obtain a special discount token for a food provided by a predetermined restaurant connected to a financial institution. The user 130 and 140 can get a digital food token back from the restaurant. By doing so, the user 130 and 140 can save money and the customer profiles of the financial institution can be increased. Accordingly, all participants can benefit. This infrastructure has its own drawback in the aspect of security operated by a high-level security communication wrapper distinguishing the operation of a financial institution from other public services.

An ATM of a bank coupled with a wireless LAN access point according to the present invention as described above is responsible for a predetermined number of customer areas. These ATMs function as a means valuable to additional customers of the financial institution at a less expense. These ATMs enable a new area of the financial service industry by allowing the conventional service infrastructure to add a series of services.

Some financial institutions trying to promote permanent financial services have used ATMs for a long time. This ATM is a backbone for providing permanent services. The present invention uses this existing infrastructures in order to provide additional financial services and non-financial services at a lower cost. In order to enable more various new services the ATM has been improved through an implemented access point. The basic structure of the present invention focuses on an access point implemented in an ATM, and discloses a usage model of the present invention. One access point or a plurality of access points can be integrated in an identical ATM depending on an environment in which the ATM is used.

In electronic commerce, a series of new technologies continuously generate new backbone networks integrated seamlessly to a server of a financial institution. However, overlapping costs for infrastructure facilities put heavy burdens to users and institutions. Unlike this, a bank ATM coupled with a hardware access point that can be commonly used reduces the cost burden, provides improved functions, and contributes to the increase of customers. According to this method, financial institutions can utilize an expensive machine used only for cash withdrawal and/or deposit, and increase use of wireless connection.

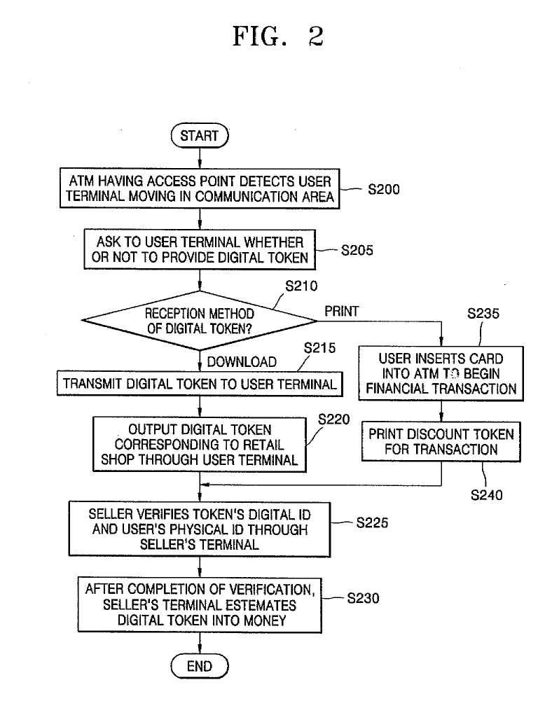

FIG. 2 is a flowchart of a purchasing process of a user using a digital token in a shopping mall.

An access point integrated in an ATM needs to be accessed individually for depositing or withdrawing money. Individuals who don't trust the security mechanism of the Internet may use an ATM to receive tokens that can be used as cash for one-off transaction. This token may be any one of a digital token and a printed token. A remote user can store a digital token in the user's PDA, smart phone or a laptop computer in order to purchase goods in a shop or food in a restaurant. These tokens are used only once, and cannot be transmitted to another system. These tokens are hash tokens controlled by public authorization, and can be improved for a security purpose.

If a user enters into a WLAN access area, an ATM having an access point according to the present invention detects the user terminal and authorizes the terminal in operation S200. The software application of the ATM having the access point asks the user whether or not a special discount token for purchase is needed in operation S205. If the user selects token download in operation S210, the ATM having the access point transmits a digital token to the user terminal in operation S215. The user terminal such as a PDA, smart phone, and an arbitrary WLAN apparatus, stores the received digital token in a memory disposed in the terminal. When the token is downloaded, the user can select a token desired to be downloaded or the category of the token. Through this process, a series of discount tokens provided by a retail seller who wants to solicit customers through special sales are provided to users. The retail seller is connected to related financial institutions, and according to this, a situation in which the user, retail sellers, and financial institutions all benefit together is generated. In this transaction, all participants will benefit from this infrastructure. According to this service, the retail seller and financial institutions can obtain much wider customer profiles, and as a result, advertisement and marketing expenses are reduced.

After that, the user uses the token in the related retail shop. For improved security, the token has the digital identification (ID) of the individual, and the individual who wants to use the token should present his/her ID card in the related shop. For this, the user outputs the digital token in the retail shop or restaurant stored in his/her terminal apparatus and presents the token in operation S220. Then, the seller asks the user to present an ID, and then verifies the digital ID of the token and the physical ID of the user by using the sellers terminal apparatus in operation S225. If the verification is completed, the terminal apparatus of the seller performs conversion of the presented digital token into money in operation S230. If the digital token is proved to be a counterfeit, the seller refused to receive the token.

If the seller presents the token to a financial institution, the financial institution automatically transfers money for payment of the token from the account of the user to the account of the seller. The financial institution can establish high-level customer profiles and promote more transactions electronically by a process to be explained later. A user sensitive to security that is the drawback of this wireless digital technology approaches to the ATM access point physically, and by using his/her cash card or credit card, can perform a transaction to print a token.

The user selects reception of a physically printed token in operation S210, and goes to an ATM having an access point. The user inserts his/her bank card to the ATM and initiates financial transaction in operation S235. Then, the user executes a print function provided by the ATM having the access point to print a discount token for transaction in operation S240. This token is presented to a seller like a check and then, operations S225 through S230 are performed. Accordingly, the transaction is similar to the digital transaction except that the physically printed token is deposited in a teller's window like a check. The printed token may have a lower discount rate due to the overall cost included in order to process and maintain the token for safety and security as cash.

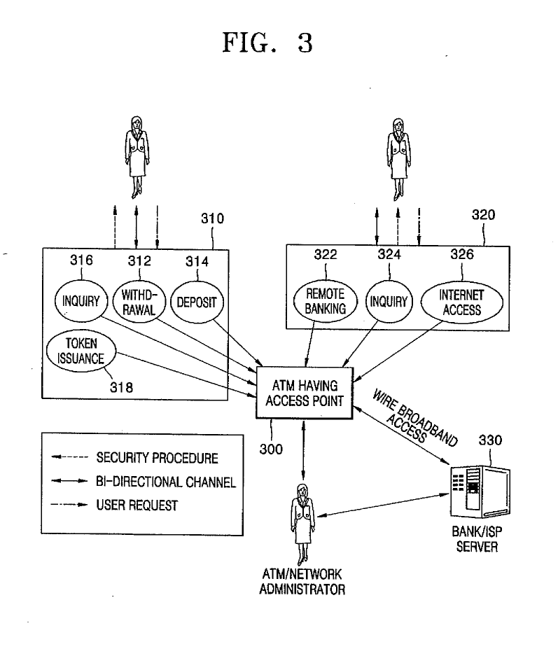

FIG. 3 illustrates services provided by an ATM having an access point according to the present invention.

The ATM 300 having an access point according to the present invention is a core element of the present invention enabling easier wireless and physical ATM access. The conventional ATM user can physically approach the ATM and use a direct access service 310. The direct access service 310 includes a token print service 318 in addition to the conventional banking services such as withdrawal 312, deposit 314, and inquiry 316.

A WLAN user can user a wireless access service 320. In the wireless access service 320, remote banking transaction 322, inquiry 324, and a series of additional services 326 for public Internet service can be used. The service provided for the public Internet use includes Internet telephone (VoIP), multimedia conference, text message, and other video and voice services (voice and video over IP, or V2oIP) on the Internet protocol (IP). There are countless services available to a wireless user and those services can be expanded. In FIG. 3, names are given only to basic profiles of the infrastructure.

The access point disposed in the ATM according to the present invention is connected to a switch which interconnects a number of ATM access points to a backbone server. Compared to the conventional public telephone network, a server farm is formed with financial institutions/Internet service providers servers connected to the ATM access point through a wire broadband connection. In FIG. 3, names are given to different subjects including an ordinary physical ATM user, a WLAN ATM user and a network administrator. FIG. 3 illustrates different message types including a user request, a bi-directional data/voice communication and a security procedure.

Furthermore, the ATM having the access point according to the present invention can provide a “wireless conference service” by which a client of a financial institution can hold a conference communication wirelessly with a customer service staff member. The V2oIP and multimedia communication services provided by the ATM having the wireless communication network access apparatus and the access point generates financial and non-financial services in a new region using a low-cost financial service infrastructure.

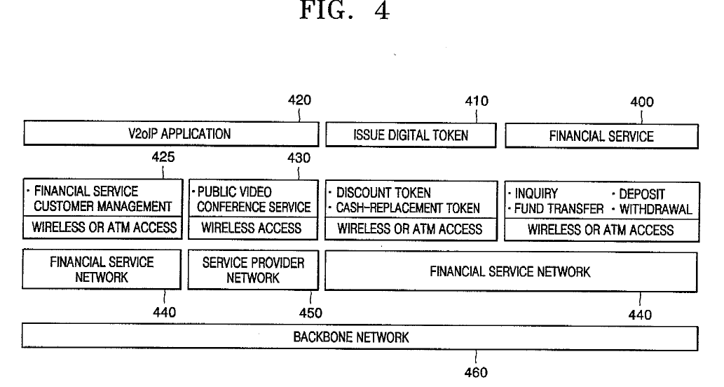

FIG. 4 illustrates an operation profile of software installed in an ATM having an access point according to the present invention.

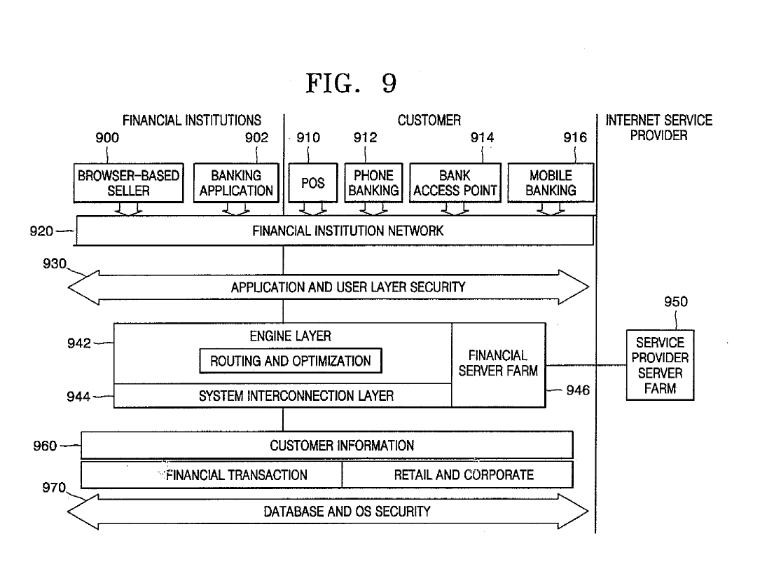

Referring to FIG. 4, if the software recognizes a wireless apparatus of a user existing in a service area, a mobile agent mounted on the wireless apparatus of the user is activated. The ATM access point mobile agent running on the wireless apparatus of the user provides three major services. The services performed by the ATM access point mobile agent include a financial service 400, a digital token issuance service 410, and V2oIP service 420 including public Internet access. The level of the financial services is improved by the ATM having the access point according to the present invention including the additional service portfolio. FIG. 9 illustrates a service stack structure and service flow of the ATM. The issuance of a digital token and related transaction flow are the same as described above with reference to FIG. 2.

The user of the ATM access point drives the V2oIP service 420 physically or in a remote place, and the V2oIP service application is connected to a financial service customer management 425 to discuss related user issues. The user can also use the access point disposed in the ATM by using an arbitrary wireless apparatus in order to request a public video conference service 430. While the financial service customer management facility is processed on a financial network 440, the public conference request facility is processed on a service provider network 450. This structure may vary according to circumstances. This integration of networks is to maintain a safe access to a financial service in a backbone unit. The connection characteristic of the backbone network 460 depends on the design of a network. The scope of the present invention is limited to use of additional financial services, use of non-financial services through the conventional financial service networks, and the integration of public Internet service for customers of financial institutions through an ATM access point.

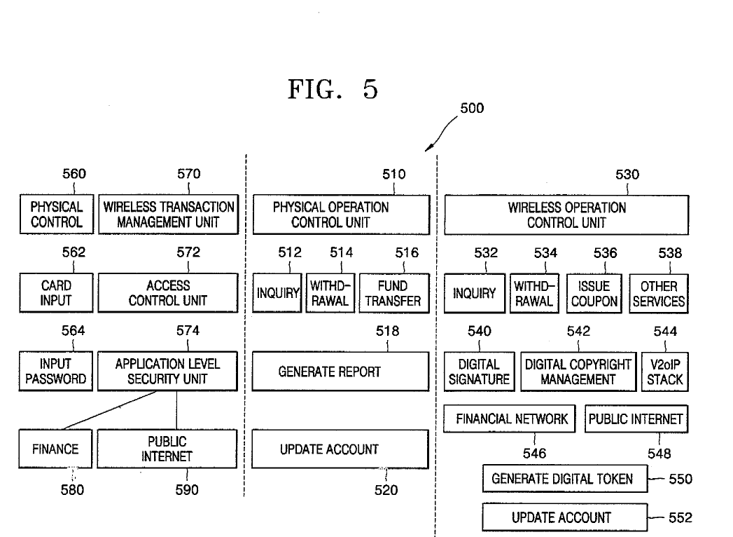

FIG. 5 illustrates a protocol stack of an ATM having an access point according to the present invention.

Referring to FIG. 5, the ATM access point software 500 controls two different users, a direct access user and a remote access user who accesses the ATM access point from a remote place. In FIG. 5, in order to show operations of the system, different elements are presented so as to be clearly distinguished. Each element operates as one software stack and the differences of these elements are shown only for clarity. A physical operation control unit 510 controls operations related to the conventional financial services as well as additional services for VoIP call connection to customer service staff members linked to other service layers 538. Also, the physical operation control unit 510 generates a print token in addition to the conventional banking services. Part of this software is coupled with new software according to the present invention and is distinguished from basic conventional operations.

The conventional banking operations are performed in the physical operation control unit 510 and, not limited to inquiry 512, includes deposit and/or withdrawal 514 and fund transfer 516. Furthermore, the operations related to the conventional ATM includes generation of a report 518 and update of transaction details 520.

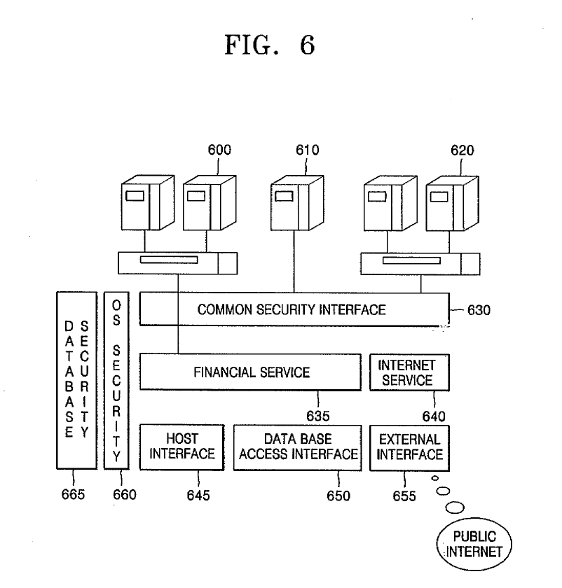

A wireless operation control unit 530 is an element added to the conventional ATM and enables inquiry 532 and fund transfer 534 on a wireless apparatus. As described above with reference to FIG. 2, this software 500 performs a special function generating a digital token for shopping. The stack of the software 500 includes a series of additional services 538 such as public Internet, Internet telephone, financial service customer management, public conference service, multimedia integration and text messaging. These services 538 are offered by using SIP on a V2oIP stack 544 implemented in the ATM access point. Also, the stack of the software 500 is formed with elements managing a digital signature 540 for a security purpose and digital copyright management 542 for multimedia download. These services 532 through 544 are implemented on a financial network 546 and a public network 548, and a digital token generation function 550 is added. The update 552 of transaction details is performed when a following download is performed. Interconnectivity of a backbone will be explained later with reference to FIG. 6.

In explaining the function of the physical control unit 560, in order to explain differences of two procedures, only the remaining function excluding the function of the wireless transaction management unit 570 are considered. A physical control unit 560 performs card input control 562 and security number request 564. A wireless transaction management performs a complicated security procedure including access control 572 and application level security 574. Security context and level vary according to the purpose based on whether a service is the financial services 580 or the other public Internet service 590.

As described above, the financial institution enables easier Internet use for other smart phones and WLAN apparatuses through already existing low-cost backbone networks. A bandwidth and security are constraints for utilization of this infrastructure facility, and these constraints are overcome by the ATM having the wireless communication network access apparatus and access point according to the present invention easily implementing ubiquitous computing. Also, other improved services controlled by the present invention includes downloading music and movies and digital copyright management for the downloading. When compared to the conventional public networks using already established backbone networks of financial institutions, profits from saved expenses are given to customers such that the customer assets of financial institutions are increased.

FIG. 6 illustrates a basic infrastructure providing interconnectivity and security between a financial service network and a service provider network.

Referring to FIG. 6, this network infrastructure contributes to making all future ATM access available for use. The ATM access point has an additional security wireless access layer 630. The ATM 620 having the conventional ATM 600, a seller financial apparatus 610, and an access point according to the present invention access a network through a common security interface 630. Financial services are provided through a financial network 635, and the Internet services are provided by service providers. Also, for higher security, a host interface 645, a database access interface 650, and an external interface 655 are provided. The security of an operating system and the database are maintained in a broad range through security engines 660 and 665 with vertical layers. The external interface 655 for this system maintains security on external access from a public Internet domain, and the security basically refuses all suspicious arbitrary actions.

The operation of the security structure will now be explained. The user accesses an ATM wireless access point of a bank using bi-directional authentication mechanism. A first authentication includes the account number of the user, and a second authentication includes a secret online transaction number transferred to the user through a security channel using a developed WLAN security mechanism. A single hash access number of the user corresponds with RSA ACE/Server software and the compatibility and integrity are examined. If the corresponding number is valid at that time point, the user can access the network. If the user wants to access the network through the wireless access point by using a protected extensible authentication protocol (PEAP) encryption mechanism to strengthen 802.1x security, the network asks the user to request authentication. This enables multi-authentication for cut-off of a link or negotiation of integrity.

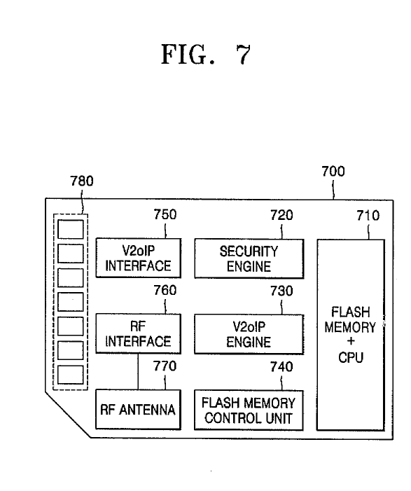

FIG. 7 illustrates a detailed structure of an ATM access point implemented as a chip according to the present invention.

Referring to FIG. 7, the chip 700 is designed so that the ATM access point can maintain security and provide improved services at a lower price. Like the conventional chip, the chip 700 is formed with a flash memory and a CPU 710, and further includes an additional security engine 720, a V2oIP engine 730, and a flash memory control engine 740 to access an I2C apparatus at a high speed. The interface for the chip 700 is formed with a V2oIP interface 750 for accessing a broadband Ethernet, and an RF interface 760 with an embedded RF antenna 770. The number of antennas can be increased later in order to implement multiple contact points on the ATM access point. A connector 780 connects the chip 700 to a hardware board.

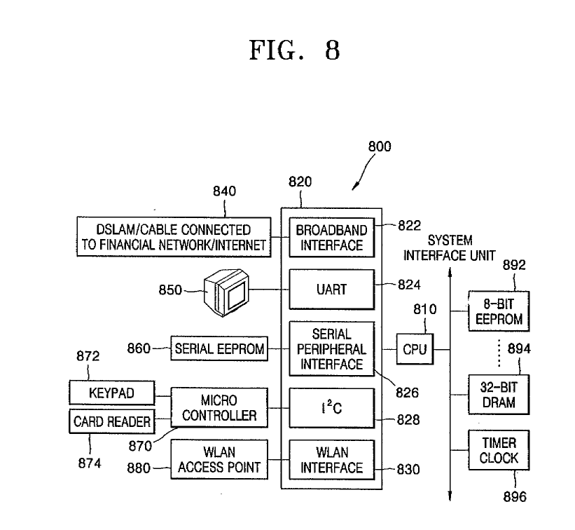

FIG. 8 is a block diagram of the hardware structure of an ATM having an access point according to the present invention.

Referring to FIG. 8, the ATM 800 having the access point according to the present invention includes a CPU 810, an external apparatus interface unit 820, a financial network/Internet access unit 840, a display apparatus 850, a serial EEPROM 860, a microcontroller 870, a WLAN access point 880, and a system interface unit 890.

The CPU 810 controls the entire operations and the operations of each element. The external apparatus interface unit 820 is formed with a broadband interface 822, a UART 824, a serial peripheral interface 826, an 12C 828, and a WLAN interface 830. The broadband interface 822 provides external interface connection for a DSLAM/cable connected to a financial network and/or an Internet service provider. The display apparatus 850 is connected to the UART 824. The serial EEPROM 860 is connected to the serial peripheral interface 826, and input apparatuses such as a keypad 872 and a card reader 874 are connected to the I2C interface 828 through the microcontroller 870, thereby connected to the system interface unit 890. The WLAN interface 830 is provided for connection with the WLAN access point 880. The above interfaces are all interconnected with the CPU 810. Other conventional apparatuses are interconnected with a system bus having the EEPROM 892, a DRAM 894, and a clock 896.

FIG. 9 illustrates a full banking procedure and a network level integrated state of a financial network having the Internet service provider infrastructure.

Referring to FIG. 9, a financial institution and a user access a financial network 920 through a common security interface by using their respective network access means. The network access means of the financial institution includes a browser-based seller 900 and a banking application 902. The network access means of the user includes a point of sale (POS) unit 910, a phone banking unit 912, and a mobile banking unit 916. The financial institution network 920 provides access to a series of services, and includes some security layers including an application and user layer security 930.

Next, services are processed after interconnected in an engine layer 942 performing routing to appropriate elements and service optimization through a system interconnection layer 944. Then, a financial server farm 946 is connected to a service provider server farm 950 providing interconnection of this service. Customer information 960 is accessed through another security information layer providing database security. The database and operating system security 970 is a vertical element, and operates on all platforms for all connections, and varies according to accesses by a financial institution employee, a financial institution customer, and other users.

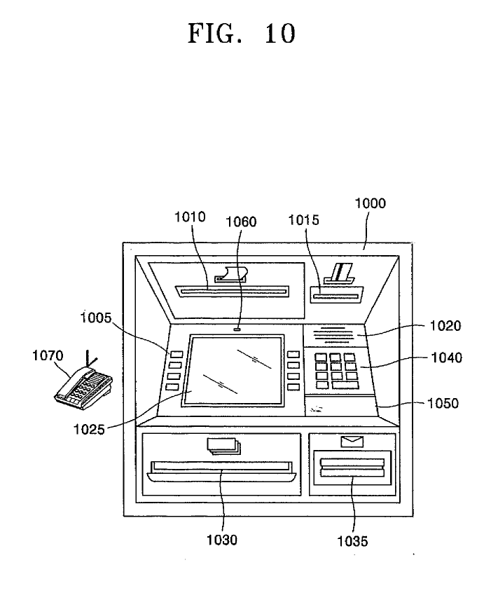

FIG. 10 illustrates the appearance of an ATM having an access point according to the present invention.

Referring to FIG. 10, the ATM 1000 having the access point according to the present invention includes the conventional ATM elements, including selection buttons 1005, a printer 1010, a card reader 1015, a speaker 1020, a monitor 1025, a cash output unit 1030, a cash input unit 1035, and a keypad, and further includes a wireless access point 1050, a camera 1060, and a telephone 1070 according to the present invention.

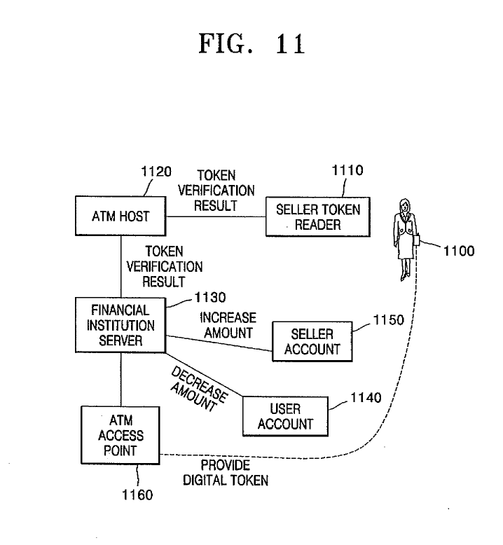

FIG. 11 illustrates a money transfer process when a user uses a digital token in a shop through an ATM having an access point according to the present invention.

Referring to FIG. 11, a user having a user terminal 1100 such as a smart phone and a PDA presents a digital token output on the user's terminal, to a seller.

A seller token reader 1110 kept by the seller verifies the digital token presented by the user and keeps the seller token. After verifying the token output on the user terminal 1100, the seller token reader 1110 transmits the verification result to an ATM host 1120.

Then, based on the verification result transferred by the ATM host 1120, a financial institution server 1130 transfers payment money from the user account 1140 to the seller account 1150. ATM access point 1160 operates as a source of the digital token.

Meanwhile, billing transaction accompanying the issuance of the token and the providing of Internet access service is performed by a billing unit of the financial institution server.

A billing algorithm performed by the billing unit of the financial institution server can be changed appropriately for a user by the network provider and/or the financial institution based on the time, the state of the user account and a marketing event available at the time of the use. However, the algorithm does not provide an accurate analysis of the billing based on an accurate amount of received data, but affects cookies operating in the user apparatus responding according to the amount of received data and the connected time.

The billing algorithm updates records at each predetermined period in order to prevent loss of records when a wireless link is cut off. The financial institution and/or service provider confirms a digital receipt and then records the usage amount from the user account automatically. By the billing method in proportion to the usage amount of the reliable wireless Internet service with a lower service fee, the financial institution can increase the number of customers and through a special discount policy for customers, can promote digital shopping.

As described above, the present invention relates to implementation of a WLAN access point on the ATM system connected to the financial institution server through a wire network. The system according to the present invention allows easier processing of the digital token and other printing, and enables wireless users to access an access point ATM in order to perform a remote transaction with a financial institution service integrated with the service provider facilities.

Meanwhile, the system according to the present invention focuses on simple expansion of an ordinary ATM structure in order to combine the WLAN access point to be integrated in the ATM. The system according to the present invention defines an access point connected to an ATM in order to promote new service areas capable of improving financial institution services for major customers of banks based on a economic infrastructure. The system according to the present invention can print out tokens for foods and tokens for other purchases that can be used for buying food or shopping in a restaurant or a selected retail store in another public place linked to a bank. According to this connection to a plurality of banking services, both consumers and sellers in the shop can directly connect their money transactions to accounts of financial institutions, and can handle petty money. Accordingly, theft can be prevented and security of shops can be improved.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the ATM having the access point and the method for providing financial services using the ATM according to the present invention, shopping methods and financial transactions performed in the traditional environments can be changed in response to a next-generation financial service and security request, and use of digital cash tokens or printed cash tokens that prevented crimes occurring in shopping malls can be promoted. Furthermore, users can receive remote financial services from their locations when their have a meal or go shopping. In particular, with the advanced software system and the method for billing in proportion to the usage amount, billing to users is enabled. The WLAN access point having the V2oIP added to the conventional ATM structure and having the multimedia stack improving the security of a wireless access to the financial institution network which usually has a very weak security opens a road to provide new services. The integrated bank ATM coupled with the WLAN access point having the V2oIP promotes new types of services. Accordingly, financial institutions can increase the number of users for each ATM infrastructure without adding an expensive ATM terminal.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for providing financial services by using an ATM installed in a public place including a shopping mail and providing financial services including account inquiry, deposit and withdrawal, the method comprising:
sensing a wireless communication terminal of a user traveling in the communication area of an access point disposed in the ATM;
activating a mobile agent installed in the sensed wireless communication terminal of the user, and asking the user through the wireless communication terminal whether or not the user requests a digital token capable of buying goods and services; and
if a message requesting to deliver the digital token from the wireless communication of the user is received, transmitting a digital token corresponding to the user to the wireless communication terminal of the user.

2. The method of claim 1, wherein a digital ID unique to the user is allocated to the digital token and the digital token is a hash token controlled by public authentication.

3. The method of claim 1, further comprising:
in response to the user's request providing to the wireless communication terminal a V2oIP service including at least one of public Internet access, Internet telephone, financial service customer management, public conference service, multimedia integration and text messaging, and provided by using SIP on the V2oIP stack.

4. The method of claim 1, wherein the digital token is used in restaurants and shops located in a place where the access point is installed, and recognized and verified by a token reader disposed in the restaurants and shops.
